(19) United States
(12) Patent Application Publication
(10) Pub. No.: US 2003/0148251 A1
(43) Pub. Date: Aug. 7, 2003

(54) Educational systems and methods relating to fossils

(76) Inventor: Jacqueline Drecksel, Salt Lake City, UT (US)

Correspondence Address: TRASK BRITT, P.O. BOX 2550, SALT LAKE CITY, UT, 84110, US

(21) Appl. No.: 10/061,137

(22) Filed: Feb. 1, 2002

(51) Int. Cl. G09B 23/40

(52) U.S. Cl. 434/299

(57) ABSTRACT

Systems and methods for teaching subjects related to the collection and preparation of collectible samples, such as fossils. In one exemplary embodiment, a quarry, or “dig” is provided where students may collect samples, recreating the experience of fieldwork. Instruction on the collection of samples may be given during collection. A student may take a collected sample to a provided learning center, or preparation laboratory, is provided to prepare the sample for study or display. Instruction on the preparation of the sample and what may be learned from the sample may be provided at the same time.

### FIELD OF THE INVENTION

The present invention relates to educational systems and “hands-on” methods for teaching that utilize samples to reinforce concepts. More specifically, some embodiments of the present invention are directed to simulating the discovery and preparation of fossils.

### BACKGROUND OF THE INVENTION

There is a great deal of interest in prehistoric life and the study of fossils. Television shows, movies and books about prehistoric animals and prehistoric life enjoy almost continual popularity. Rather than merely be entertained, a large percentage of those interested in prehistoric life seek to be educated about their interests. Information concerning paleontology, biology, archeology and related disciplines is widely available for those interested. Fossils and reproductions of fossils are popular items for education and display. The process of obtaining and preparing a fossil for research or display is an experience that many would like to have.

Fossils, like other geologic specimens, typically occur in certain formations. The ages and types of fossils vary with the different compositions of fossil-bearing formations. Since fossils are only found in certain formations, those wishing to collect fossils must travel to those locations. Not only is this inconvenient for those living at a distance from any fossil beds, but even those who live in relatively fossil-rich areas may have to travel hundreds of miles to collect fossils from different eras. For example, in the western U.S. where fossils are considered relatively common, limestone strata-bearing aquatic fossils from an ancient lake with an age of 40 to 60 million years may be found in the area around Fossil Lake National Monument in Wyoming. Older fossils, such as dinosaur bones from the Mesozoic Era (150 to 165 million years ago) are several hundred miles away in the area around Vernal in Eastern Utah, and even older Paleozoic Era (245-300 million years ago) marine fossils, such as trilobites, may be found in shale strata area around the town of Delta in western Utah. Often these fossil bearing formations are in areas that are dedicated for scientific research, are National Parks or National Monuments, or are otherwise closed to the general public.

Reproductions of fossils are available for those interested in fossils. For example, U.S. Pat. No. 3,769,114, issued Oct. 30, 1973 and U.S. Pat. No. 3,917,786 issued Nov. 4, 1975 are directed to the manufacture of such reproductions. A photograph of a fossil is printed on paperboard, which is then embossed to copy the three dimensional aspects of the fossil. The paperboard is then mounted on a stone to mimic the original fossil. While this method allows those interested to own a reproduction, it fails to provide them with the experience of owning an actual fossil, of collecting that fossil and of preparing that fossil.

U.S. Pat. No. 6,216,896 issued on Apr. 17, 2001 represents one attempt to provide an enhanced fossil-owning experience. A reproduction of a fossil integrated into a reproduced rock is prepared from clay and fired in a kiln to harden. A second layer of a softer clay is then layered over the reproduction and fired. The softer clay may be scraped off by a purchaser, somewhat simulating the experience of cleaning a fossil. U.S. Pat. No. 5,94,712 is directed to an educational kit that also attempts to provide an enhanced fossil-owning experience. A miniaturized reproduction of a dinosaur skeleton and a miniature reproduction of a paleontologist's tool kit are provided. An adult hides the miniature skeleton and supervises a child in finding it. While these products provide a child with the experience of obtaining a fossil reproduction, they do not provide a realistic experience of either collecting or preparing a fossil for use. Further, they fail to provide the user with an actual fossil.

Kits that provide a user with an actual fossil are known. These kits consist of a segment of fossil-bearing rock, known to contain a fossil, such as a limestone slab known to contain a fossil fish. Appropriate tools for cleaning the fossil and cleaning instructions are also provided. The purchaser is thus provided with a fossil and the equipment needed to prepare and display that fossil. These kits have proven very popular as they provide an enjoyable and educational experience. However, like the reproductions, these kits fail to provide the user with the experience of collecting a fossil from its natural surroundings. Similarly, the preparation experience is limited to cleaning the fossil for display following a set of instructions. A system or method that provides a user with the experience of collecting an actual fossil in the field and preparing that fossil for use, without requiring the user to travel to the naturally-occurring fossil bed, would be advantageous. Such a system or method that includes fossils from different eras and locations to be collected and investigated would be further advantageous.

### SUMMARY OF THE INVENTION

The present invention is directed to systems and methods for teaching subjects related to the collection and preparation of samples, such as fossils. In one exemplary embodiment, a quarry, or “dig” is provided where students may collect samples, recreating the experience of fieldwork. Instruction on the collection of samples may be given during collection. A student may take a collected sample to a learning center or preparation laboratory that is provided to prepare the sample for study or display. Instruction on the preparation of the sample and what may be learned from the sample may be provided at the same time.

### DESCRIPTION OF THE DRAWINGS

FIG. 1 illustrates one possible embodiment of a sample collection area for use with one illustrative embodiment of a system in accordance with the present invention;

FIG. 2 illustrates one possible embodiment of a sample preparation area for use with one illustrative embodiment of a system in accordance with the present invention; and

FIG. 3 is a flowchart illustrating one possible embodiment of a process for providing an educational sample collection and preparation experience, in accordance with one aspect of the present invention.

### DETAILED DESCRIPTION OF THE INVENTION

The present invention relates to educational systems and “hands-on” methods for teaching that utilize samples to reinforce concepts. More specifically, some embodiments of the present invention are directed to simulating the discovery and preparation of fossils.

It will be appreciated by those skilled in the art that the embodiments herein described, while illustrating certain embodiments, are not intended to so limit the invention or the scope of the appended claims. Those skilled in the art will also understand that various combinations or modifications of the embodiments presented herein can be made without departing from the scope of the invention. For example, it will be appreciated that the methods and systems discussed herein, while particularly suited for education and entertainment concerning fossils and paleontology, may easily be adapted for educating about other types of fieldwork involved in other scientific disciplines. Exemplary alternative embodiments directed to teaching archeology, geology, field biology, and so forth are possible and will also be discussed further herein. All such alternate embodiments are within the scope of the present invention.

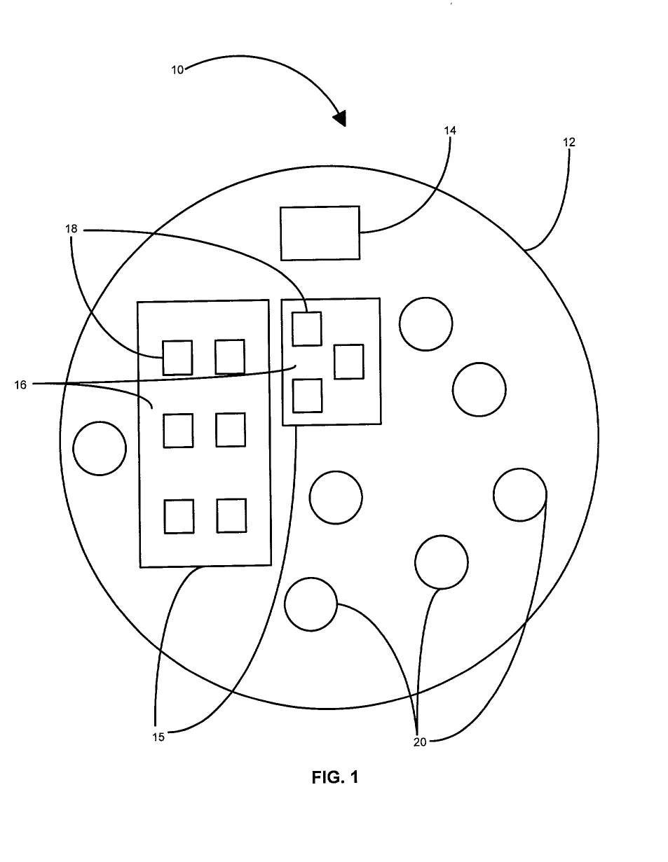

In drawing FIG. 1, a box diagram representation of a simulated collection area 10, useful in practicing some embodiments of the present invention, is shown. An area 12 is configured to simulate a location where an item of interest naturally occurs, such as a “dig” at a fossil bed or archeological site, or a quarry where geologic samples are collected. Area 12 maybe an indoor area, such as a room, hall, pavilion or other structure; alternatively, area 12 may be an outdoor area where appropriate. The configuration of area 12 to simulate the location where the item of interest naturally occurs may be accomplished in any desired manner. For example, where area 12 is an indoor area, the room may be painted to resemble the appropriate outdoor surroundings.

A number of simulation items 20 may be disposed in the area 12 to further enhance the simulation. Simulation items 20 may include any item that can be used to simulate the appearance of a location where an item of interest 16 naturally occurs. Plants and geologic formations from the naturally occurring location, rock strata that lie above and below the bulk collection material 16 in the natural location, a recreation of a gorge or stream, dioramas and constructions that mimic the appearance of a dig or exploration site are all examples of some potential simulation items. Where area 12 is an indoor area, environmental conditioning, such as heating, air conditioning, sun lamps, humidifiers or dehumidifiers may be used to further enhance the simulation. The recreation of appropriate naturally occurring sounds, such as animal noises, wind sound and so forth may also be used, as may the appearance of naturally occurring animals.

A bulk collection material 16 is placed into area 12. The bulk collection material 16 contains collectible items, samples, or items of interest 18. Bulk collection material 16 may be any material in which an item of interest 18 naturally occurs. For example, where items of interest 18 are aquatic fossils, the bulk collection material 16 may be a strata of stone containing those fossils. Alternatively, the bulk collection material 16 may be a simulated material with the items of interest 18 placed therein. For example, where items of interest 18 are archeological items, such as coins or tools, the bulk collection material 16 may be appropriately appearing layers of earth from which the archeological items (i.e. items of interest 18) may be retrieved. It will be appreciated that, where appropriate and desired, the items of interest 18 may similarly be reproductions, such as reproductions of certain fossils, archeological specimens, or gemstones, in order to provide a thorough educational experience where the scarcity or expense of using the actual items would be prohibitive.

Bulk collection material 16 may be integrated into the appearance of the area 12 to further simulate the naturally-occurring location. For example, where the bulk collection material 16 is fossil-containing rock, it may be placed in a geologic diorama including surrounding strata and other simulation items 20 that may be found at a location where the bulk collection material 16 naturally occurs.

Collecting tools 14 for extracting the items of interest 18 from the bulk collection material 16 may also be provided in area 12. These may include shovels, brushes, chisels, picks trowels, screens and any other tool commonly used for such a purpose. The specific collecting tools 14 provided may vary depending on the type of items of interest 18 and bulk collection material 16 provided. Workbenches, supply cabinets and any other necessary items may also be supplied in the area 12. Where such items are supplied, they may be integrated into the simulated appearance of the naturally occurring location, such as a fossil dig. A space for instruction, including all necessary elements, such as seats, tables, and audiovisual components may be provided in area 12 to facilitate instructions in extracting the items of interest 18.

A user entering the area 12 may thus be provided with collecting tools 14 and appropriate instruction to extract an item of interest 18 from the bulk collection material 16, furnishing that user with the experience of collecting an item of interest 18 in its naturally-occurring location. Any number of simulated collection areas 10 may be provided at a location, such as a store or museum, each containing different items of interest and allowing a user to experience collecting different items of interest at one central location. At a single location for example, a first collection area 10 may contain aquatic fossils from and simulate the area of Fossil Lake, Wyo. and a second collection area 10 may contain older dinosaur bone fossils (or reproductions) and simulate an appropriate area, such as Dinosaur Cove of Victoria, Australia. It will be appreciated that a simulated collection area 10 made in accordance with the principles of the present invention thus provides a location where instruction in proper collection techniques, or the experience of collecting item of interest from its naturally occurring location can be provided, without requiring users to travel to the naturally occurring location or interfering with ongoing work at such location.

A single simulated collection area 10 may be constructed to include a number of stations 15 where items of interest 18 can be extracted from the bulk collection material 16. It will be appreciated that each station may contain different items of interest and/or different bulk collection materials 16 as desired. In one exemplary embodiment, one station 15 may hold items of interest in a bulk collection material that is easily extracted from, allowing the items of interest 18 to be easily collected, as by a small child. A second station 15 would contain the items of interest 18 in a more realistic bulk collection material 16 that requires more effort to successfully extract an item of interest 18, providing a more realistic collection experience to an older user.

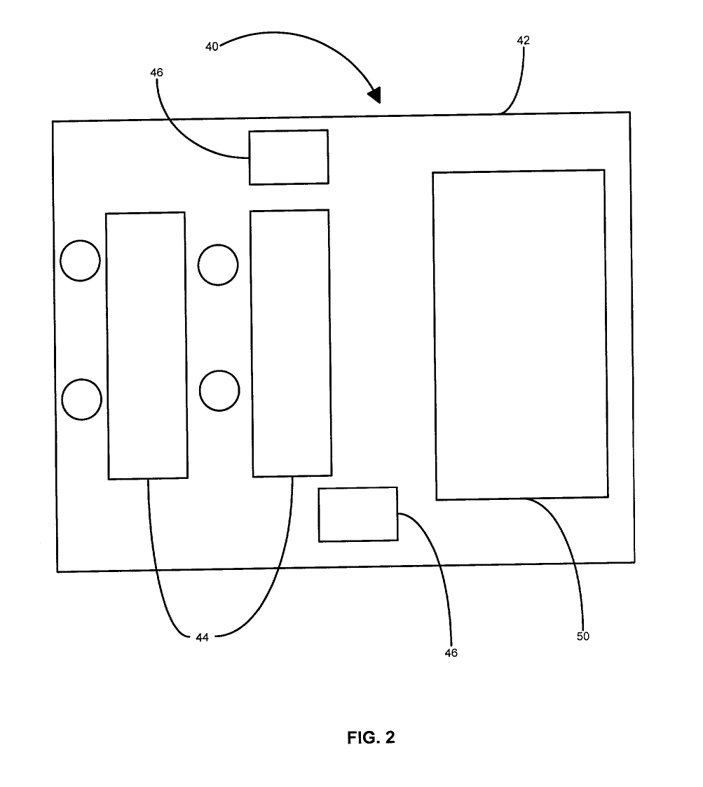

Referring to drawing FIG. 2, a block diagram of one possible embodiment of a learning center 40, in accordance with an embodiment of the present invention is shown. Learning center 40 is set up in an area 42 that is designed to simulate the appearance of a facility where items of interest 18 would normally be processed when extracted from their naturally occurring location. For example, area 42 may be designed to appear as a preparation laboratory, where fossils are extracted and cleaned of surrounding material and studied to elucidate information therefrom. Alternatively, area 42 may simulate a field laboratory where initial work is done on samples allowing them to be transported to a larger facility. In such a “field lab” embodiment, area 42 for learning center 40 may be continuous with area 12 of FIG. 1 or may alternatively consist of an area 42 separate and apart from area 12.

It will be appreciated that where the items of interest 18 are items other than fossils, area 42 may be configured to simulate the appropriate processing facility, such as, for example, an assaying laboratory or a gemstone processing facility. All such alternative embodiments are within the scope of the present invention.

One or more workstations 44, such as lab benches, are disposed in area 42 where items of interest 18 may be prepared. A workstation 44 will preferably contain all the tools 48 and supplies 46 necessary for preparation of an item of interest 18. It will be appreciated that the workstations may take any desired appearance and that tools 48 and supplies 46 may merely be made available in area 42.

Preparing the items of interest 18 may take many forms, depending on the item of interest 18, and may result in the item of interest 18 being ready for use or study or ready to be displayed. For example, where the items of interest are fossils, the preparation may include removing part or all of the bulk collection material 16 adhering to the extracted fossil and measuring aspects of the fossil to make determinations, such as species, age, cause of death, and so forth. Preparation could further include preparing the fossil to be displayed as a museum piece or for decoration. Where the item of interest 18 differs, the preparation may accordingly differ. For example, if the item of interest 18 is a gemstone extracted from an appropriate bulk collection material 16, preparation may include cleaning the gemstone and preparing it for industrial use or for use as jewelry, determining the classification and weight of the gemstone, polishing and cutting the gemstone, or even mounting the otherwise prepared gemstone in a jewelry setting. As another example, where the items of interest 18 are archeological specimens, preparation may include cleaning the specimens using appropriate techniques, identifying and characterizing the specimens, and preparing the specimens for proper storage and/or display.

The tools 48 and supplies 46 needed for preparation of the items of interest 18 may vary in accordance with the requirements for differing items of interest 18 and different methods and techniques for preparation thereof. Tools 48 may include any needed brushes, probes, forceps, measuring instruments, vats, cameras, hammers, saws, cutting tools, polishing cloths, stone polishing machines, heating torches, or any other required or desired tool. Supplies 46 may include solvents, cleansers, reference books, reference tables, charts and graphs, film or any other supply required or desired for a preparation process.

Area 42 may also include an instructional area 50 set off from the workstations 44, where users may be provided with instructions away from the preparation process. It will be appreciated that a learning center 40, such as that depicted in FIG. 2, made in accordance with the principles of the present invention provides an area whereby instruction in proper preparation techniques or the experience of preparing a extracted item of interest can be provided without tying up the resources of a working facility or requiring users to travel to a facility.

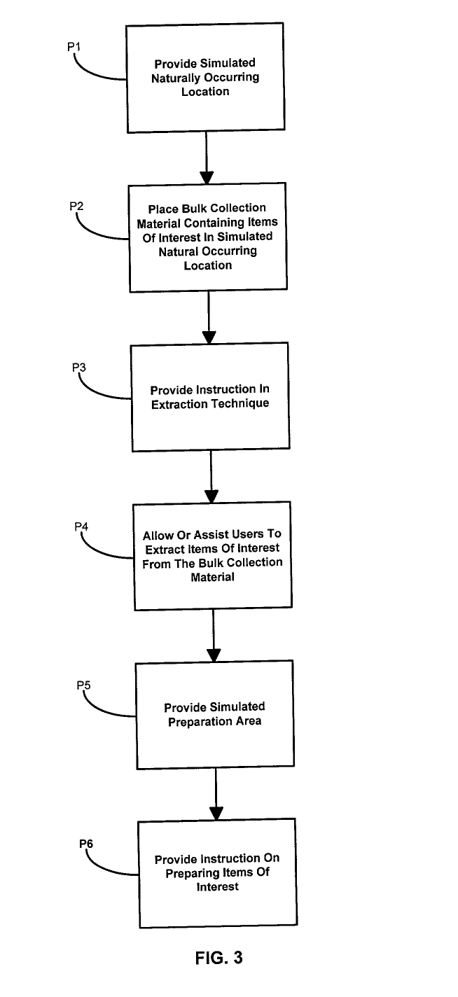

Drawing FIG. 3 depicts a flowchart of a process for providing an educational sample collection and preparation experience to a user that is in accordance with the principles of the present invention. For clarity, the process will be explained in connection with the embodiments of FIGS. 1 and 2. It will, of course, be appreciated that the flowchart is illustrative only and depicts only one possible embodiment of a process, other processes in accordance with the teachings of the present invention are possible, and any such suitable process may be used, all such processes are within the scope of the present invention.

As shown in box P1, a simulated collection area 10, discussed previously herein, is provided to mimic the appearance of a naturally occurring location of items of interest 18. A bulk collection material 16, containing items of interest 18 is provided in the simulated collection area 10, as shown in box P2. This may occur by importing a bulk collection material 16 that naturally contains the items of interest 18, such as a fossil containing strata of rock, or by placing items of interest, such as reproductions of fossils or antique coins into an appropriate bulk collection material 16. By the latter method, the level of difficulty in extracting the items of interest 18 can be varied. For example, reproductions of fossils can be placed into an easy bulk extraction material 16, such as sand, in order to provide younger children with the opportunity to extract a “fossil” and learn about paleontology.

Instruction to the users on extracting the items of interest 18 from the bulk collection material 16 may then be provided, as shown in box P3. For example, a lecture on proper collection technique maybe given, a video presentation on proper collection technique may be given, and/or hands on instruction may be given as items of interest 18 are extracted. Users are allowed to extract items of interest 18 from the bulk collection material 16, as shown in box P4, either with assistance or on their own. Further instruction may then be given.

A simulated preparation area, such as learning center 40 is provided, as shown in box P5, where users may take extracted items of interest 18 for preparation. Instruction on preparing the item of interest 18 for use or display are provided, as shown in box P6. Instruction may be given in any suitable manner, ranging from lecture, to video or multimedia presentation, to direct instruction during “hands on” preparation of the item of interest. It will be appreciated that preparation may take any form discussed herein.

Accordingly, the present invention includes methods of teaching. In a simple form, these methods may be practiced by providing an amount of bulk collection material containing a number of samples in a designated area, instructing users in proper collection technique, and directing the users to obtain a sample the bulk collection material. The designated area may be configured to mimic the appearance of a location where the bulk collection material is naturally found. The bulk collection material may be any suitable substance, as discussed previously herein, including geologic formations bearing fossils, gemstones or other items of interest as samples. Instruction in proper collection techniques may be given as desired, including lectures and direct demonstrations in the designated area, and hands-on instruction.

These methods may further include providing a preparation area for processing collected samples and instructing users in processing the samples. This may include providing the necessary equipment for processing the collected samples. Processing may refer to any preparation discussed previously herein, such as preparing a collected sample for display or preparing the sample for use by identifying particular aspects of the sample.

The present invention further includes processes for simulating fieldwork. In a basic form, this processes may be practiced by obtaining a sample from a number of samples in a bulk collection material located in a simulated fieldwork area and processing the sample for use. The sample may be any item of interest as discussed herein, and processing the sample for use may be performed as discussed herein. Processing the sample for use may include taking the sample to a simulated preparation laboratory.

It will be appreciated by those skilled in the art that illustrated embodiments herein described are not intended to limit the invention or the scope of the appended claims. Various combinations and modifications of the preferred embodiments could be made without departing from the scope of the present invention and all such modifications are within the scope of the present invention.

Thus, while certain representative embodiments and details have been shown for purposes of illustrating the invention, it will be apparent to those skilled in the art that various changes in the invention disclosed herein may be made without departing from the scope of the invention, which is defined in the appended claims.

What is claimed is:

1. An educational system, comprising:
a simulated collection area comprising an area configured to simulate a location where an item of interest naturally occurs;
a bulk collection material disposed in said simulated collection area, said bulk collection material comprising a number of said items of interest and a bulk material from which said items of interest may be extracted.

2. The system of claim 1, wherein said items of interest comprise fossils.

3. The system of claim 2, wherein said bulk collection material comprises a fossil bearing rock layer.

4. The system of claim 3, wherein said fossil bearing rock layer is integrated into said simulated collection area to simulate a fossil quarry.

5. The system of claim 1, further comprising a simulated preparation facility, said simulated preparation facility comprising an area configured to simulate a facility where said items of interest are prepared for use.

6. The system of claim 5, wherein said facility is a field laboratory.

7. A method for teaching, comprising:
providing an amount of bulk collection material in a designated area, said bulk collection material comprising one or more collectible items;
instructing a user in proper collection technique; and
directing the user to obtain one or more collectible items from said bulk collection material within said designated area.

8. The method according to claim 7, wherein providing an amount of bulk collection material in a designated area comprises providing a designated area that is configured to mimic the appearance of a location where said bulk collection material is naturally disposed.

9. The method according to 8, wherein providing said bulk collection material comprises providing at least one rock formation.

10. The method according to claim 9, wherein providing said at least one rock formation comprises providing fossil-bearing rock.

11. The method according to claim 9, wherein providing said rock formation comprises providing rock bearing at least one gemstone.

12. The method according to claim 7, wherein instructing a user in proper collection techniques comprises demonstrating proper collection techniques to the user in said designated area.

13. The method according to claim 7, wherein instructing a user in proper collection technique comprises instructing the user as the user obtains said one or more collectible items from said bulk collection material.

14. The method according to claim 7, wherein instructing the user to obtain one or more collectible items comprises instructing the user to collect a fossil from said bulk collection material.

15. A method for teaching, comprising:
providing an amount of bulk collection material in a designated area, said bulk collection material comprising one or more collectible items;
directing the user to obtain one or more collectible items from said bulk collection material within said designated area;
providing a preparation area for the processing of said collectible item;
providing the user with equipment for processing said collectible item; and
instructing the user in processing said collectible item.

16. The method according to claim 15, wherein processing said collectible item comprises preparing the collectible item for display.

17. The method according to claim 15, wherein processing said collectible item comprises identifying particular characteristics of said collectible item.

18. The method according to claim 17, wherein identifying particular characteristics of said collectible item comprises identifying a species of a fossil organism.

19. The method according to claim 17, wherein identifying aspects of said collectible item comprises identifying classification characteristics of an archeological sample.

20. The method according to claim 17, wherein identifying aspects of said collectible item comprises identifying a geological sample.
